(19) United States
(12) Patent Application Publication
(10) Pub. No.: US 2010/0143634 A1
(43) Pub. Date: Jun. 10, 2010

(54) PRESSURE-SENSITIVE ADHESIVE LAYER-CARRYING TRANSPARENT CONDUCTIVE FILM, METHOD FOR PRODUCTION THEREOF, TRANSPARENT CONDUCTIVE LAMINATE, AND TOUCH PANEL

(75) Inventors: Atsushi Yasui, Osaka (JP); Masayuki Satake, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/624,789

(22) Filed: Nov. 24, 2009

(30) Foreign Application Priority Data
Dec. 9, 2008 (JP) 2008-313441

(51) Int. Cl. C09J 7/02; B32B 33/00; B05D 5/10

(52) U.S. Cl. 428/41.8; 428/354; 427/208.4

(57) ABSTRACT

An object of the invention is to provide a pressure-sensitive adhesive layer-carrying transparent conductive film that can reduce the problem with the visibility due to the pressure-sensitive adhesive layer, when it is used in a touch panel or the like, a method for production thereof, and a transparent conductive laminate. The pressure-sensitive adhesive layer-carrying transparent conductive film of the invention is a pressure-sensitive adhesive layer-carrying transparent conductive film, comprising: a first transparent plastic film substrate; a transparent conductive thin film provided on one side of the first transparent plastic film substrate; and a pressure-sensitive adhesive layer provided on another side of the first transparent plastic film substrate, wherein the pressure-sensitive adhesive layer used in the pressure-sensitive adhesive layer-carrying transparent conductive film has a surface with a surface roughness Ra of 2 to 130 nm on the side to which the first transparent plastic film substrate is bonded.

### TECHNICAL FIELD

The invention relates to a pressure-sensitive adhesive layer-carrying transparent conductive film. After an appropriate process, the pressure-sensitive adhesive layer-carrying transparent conductive film is used for a transparent electrode of an advanced display system such as a liquid crystal display or an electroluminescence display, a touch panel or the like. In addition, the pressure-sensitive adhesive layer-carrying transparent conductive film is also used for prevention of static charge of a transparent product or electromagnetic wave shielding and for liquid crystal dimming glass, a transparent heater or the like.

### DESCRIPTION OF THE RELATED ART

Concerning conventional transparent conductive thin film, the so-called conductive glass is well known, which includes a glass member and an indium oxide thin film formed thereon. Since the base member of the conductive glass is made of glass, however, it has low flexibility or workability and cannot preferably be used in some applications. In recent years, therefore, transparent conductive films using various types of plastic films such as polyethylene terephthalate films as their substrates have been used, because of their advantages such as good impact resistance and light weight as well as flexibility and workability.

When used, the transparent conductive film forms a transparent conductive laminate, which includes a transparent plastic film substrate, a transparent conductive thin film provided on one side of the transparent plastic film substrate, a pressure-sensitive adhesive layer, and a transparent substrate bonded to the other side of the transparent plastic film substrate with the pressure-sensitive adhesive layer interposed therebetween (Japanese Patent Application Laid-Open (JP-A) No. 06-309990).

Acrylic pressure-sensitive adhesives are generally used in pressure-sensitive adhesive layers for the transparent conductive film. When bonded with an acrylic pressure-sensitive adhesive, the transparent conductive film maintains high optical transparency. Therefore, when a display device produced with the transparent conductive film is viewed in an oblique direction, a problem may occur in which grid-like unevenness or stripe-like unevenness caused by the acrylic pressure-sensitive adhesive, so called coating unevenness, appears, which may significantly affect the visibility.

Concerning the pressure-sensitive adhesive layer, it is proposed that the coating thickness and the surface roughness should be controlled. For example, it is proposed that a pressure-sensitive adhesive layer with the surface roughness controlled to be low should be formed on a protective film by a process including forming a pressure-sensitive adhesive layer on a release substrate with the release surface roughness controlled to be low and transferring the pressure-sensitive adhesive layer to a protective film (Japanese Patent Application Laid-Open No. 2005-306996). However, the problem with the visibility due to the uneven pressure-sensitive adhesive layer has not been overcome even by the technique disclosed in the patent literature.

### SUMMARY OF THE INVENTION

An object of the invention is to provide a pressure-sensitive adhesive layer-carrying transparent conductive film that can reduce the problem with the visibility due to the pressure-sensitive adhesive layer, when it is used in a touch panel or the like, a method for production thereof, and a transparent conductive laminate.

Another object of the invention is to provide a touch panel using the pressure-sensitive adhesive layer-carrying transparent conductive film or the transparent conductive laminate.

As a result of intense investigations to solve the problems, the inventors have made the invention, based on the finding that the objects are achieved with the pressure-sensitive adhesive layer-carrying transparent conductive film or others described below.

Namely, the pressure-sensitive adhesive layer-carrying transparent conductive film of the present invention is a pressure-sensitive adhesive layer-carrying transparent conductive film, comprising: a first transparent plastic film substrate; a transparent conductive thin film provided on one side of the first transparent plastic film substrate; and a pressure-sensitive adhesive layer provided on another side of the first transparent plastic film substrate, wherein the pressure-sensitive adhesive layer used in the pressure-sensitive adhesive layer-carrying transparent conductive film has a surface with a surface roughness Ra of 2 to 130 nm on the side to which the first transparent plastic film substrate is bonded.

Also, the transparent conductive laminate of the present invention is a transparent conductive laminate, comprising: the pressure-sensitive adhesive layer-carrying transparent conductive film of the present invention; and a second transparent plastic film substrate bonded to the pressure-sensitive adhesive layer of the pressure-sensitive adhesive layer-carrying transparent conductive film.

Also, the touch panel of the present invention is a touch panel, comprising at least one piece of the pressure-sensitive adhesive layer-carrying transparent conductive film of the present invention or the transparent conductive laminate of the present invention.

Also, the method for producing the pressure-sensitive adhesive layer-carrying transparent conductive film of the present invention is a method for producing the pressure-sensitive adhesive layer-carrying transparent conductive film, comprising the steps of: applying a pressure-sensitive adhesive coating liquid onto a release sheet; and subjecting the pressure-sensitive adhesive coating liquid to a first drying process at a temperature of 30 to 80° C. and an air flow rate of 0.5 to 15 m/second and a second drying process at a temperature of 90 to 160° C. and an air flow rate of 0.1 to 25 m/second to form a pressure-sensitive adhesive layer.

The inventors have found that the surface roughness Ra of the pressure-sensitive adhesive layer on a transparent conductive film, particularly, the surface roughness Ra in a direction perpendicular (orthogonal) to the longitudinal direction, significantly affects the visibility. In the pressure-sensitive adhesive layer-carrying transparent conductive film of the invention, the surface roughness Ra of the pressure-sensitive adhesive layer is controlled to be from 2 to 130 nm, and therefore the pressure-sensitive adhesive layer is formed with no coating unevenness. Thus, the degradation in visibility is reduced, which would be caused by unevenness in the coating to form the pressure-sensitive adhesive layer, and the visibility of optical devices, particularly, the visibility in oblique directions, can be improved.

### BRIEF DESCRIPTION OF THE DRAWINGS

FIG. 1 is a cross-sectional view showing an example of the pressure-sensitive adhesive layer-carrying transparent conductive film of the invention;

FIG. 2 is a cross-sectional view showing another example of the pressure-sensitive adhesive layer-carrying transparent conductive film of the invention;

FIG. 3 is a cross-sectional view showing an example of the transparent conductive laminate of the invention; and

FIG. 4 is a cross-sectional view showing another example of the transparent conductive laminate of the invention.

### DETAILED DESCRIPTION OF THE PREFERRED EMBODIMENTS

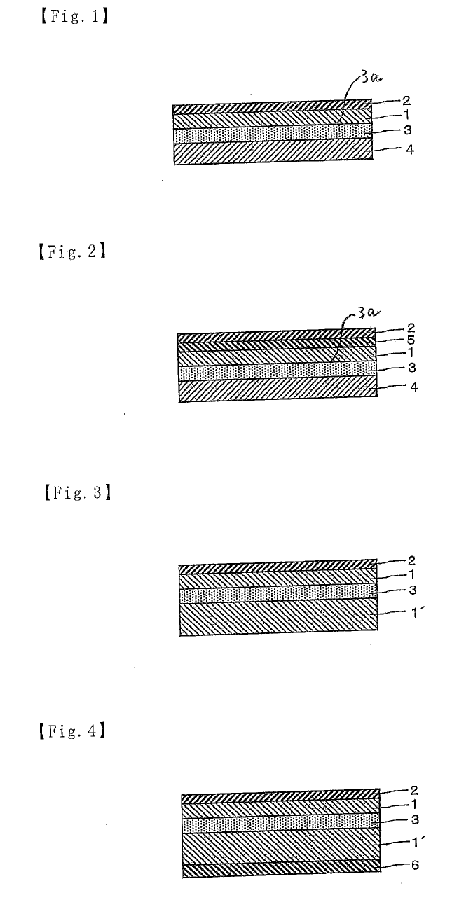

The pressure-sensitive adhesive layer-carrying transparent conductive film of the invention is described below with reference to the drawings. FIG. 1 is a cross-sectional view showing an example of the pressure-sensitive adhesive layer-carrying transparent conductive film of the invention. The pressure-sensitive adhesive layer-carrying transparent conductive film shown in FIG. 1 includes a first transparent plastic film substrate 1, a transparent conductive thin film 2 provided on one side of the substrate 1, and a release sheet 4 provided on the other side of the substrate 1 with a pressure-sensitive adhesive layer 3 interposed therebetween. The pressure-sensitive adhesive layer 3 used in the pressure-sensitive adhesive layer-carrying transparent conductive film has a surface 3a with a surface roughness Ra of 2 to 130 nm on the side to which the first transparent plastic film substrate 1 is bonded. FIG. 2 shows another example including the structure of the pressure-sensitive adhesive layer-carrying transparent conductive film shown in FIG. 1 and an undercoat layer 5 interposed between one side of the first transparent plastic film substrate 1 and the transparent conductive thin film 2. While the undercoat layer 5 shown in FIG. 2 is a single layer, the undercoat layer 5 may be a multilayered structure. The release sheet 4 is provided on the other side of the film substrate 1 opposite to the transparent conductive thin film 2 with the pressure-sensitive adhesive layer 3 interposed therebetween.

In the pressure-sensitive adhesive layer-carrying transparent conductive film of the invention, the surface 3a of the pressure-sensitive adhesive layer has a surface roughness Ra of 2 to 130 nm. The surface roughness Ra is preferably from 10 to 120 nm, more preferably from 20 to 110 nm. If the surface roughness Ra is more than 130 nm, the pressure-sensitive adhesive layer may be significantly uneven to have an adverse effect on the visibility. On the other hand, if the surface roughness Ra is less than 2 nm, there may be a significant adverse effect on the productivity.

The transparent plastic film substrate 1 to be used may be, but not limited to, various transparent plastic films. The plastic film is generally formed of a monolayer film. Examples of the material for the transparent plastic film substrate 1 include polyester resins such as polyethylene terephthalate and polyethylene naphthalate, acetate resins, polyethersulfone resins, polycarbonate resins, polyamide resins, polyimide resins, (meth) acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyarylate resins are preferred.

The thickness of the film substrate 1 is generally from 10 to 200 μm, preferably from 20 to 180 μm, more preferably from 30 to 150 μm. If the thickness of the film substrate 1 is less than 10 μm, the film substrate 1 may have an insufficient mechanical strength so that it may be more likely to be broken. On the other hand, if the thickness is more than 200 μm, the input amount may be reduced in the process of forming the transparent conductive thin film 2, and there may be a harmful effect on the process of removing gas or moisture, which may degrade the productivity.

The surface of the transparent plastic film substrate 1 may be previously subject to sputtering, corona discharge treatment, flame treatment, ultraviolet irradiation, electron beam irradiation, chemical treatment, etching treatment such as oxidation, or undercoating treatment such that the adhesion of the transparent conductive thin film 2 or the undercoat layer 5 formed thereon to the transparent plastic film substrate 1 can be improved. If necessary, the transparent plastic film substrate 1 may also be subjected to dust removing or cleaning by solvent cleaning, ultrasonic cleaning or the like, before the transparent conductive thin film 2 or the undercoat layer 5 is formed.

Examples of materials that are preferably used to form the transparent conductive thin film 2 include oxides such as tin oxide-doped indium oxide and antimony-doped tin oxide.

The thickness of the transparent conductive thin film 2 is preferably, but not limited to, 10 nm or more, in order that it may form a highly-conductive continuous coating film with a surface resistance of 1×10³ Ω/square or less. If the thickness is too large, a reduction in transparency and so on may occur. Therefore, the thickness is preferably from 15 to 35 nm, more preferably from 20 to 30 nm. If the thickness is less than 10 nm, the surface electric resistance may be too high, and it may be difficult to form a continuous coating film. If the thickness is more than 35 nm, a reduction in transparency may occur.

The transparent conductive thin film 2 may be formed using known conventional methods, while the methods are not particularly limited. Examples of such methods include vacuum deposition, sputtering, and ion plating. Any appropriate method may be used depending on the required film thickness.

The undercoat layer 5 may be made of an inorganic material, an organic material or a mixture of an inorganic material and an organic material. Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein each number inside the parentheses is the refractive index of each material. In particular, SiO₂, MgF₂, Al₂O₃, or the like is preferably used. In particular, SiO₂ is preferred. Besides the above, a complex oxide containing about 10 to about 40 parts by weight of cerium oxide and about 0 to about 20 parts by weight of tin oxide based on 100 parts by weight of the indium oxide may also be used.

The undercoat layer may be made of an inorganic material. In this case, a dry process such as vacuum deposition, sputtering or ion plating, a wet process (coating process), or the like may be used to form the undercoat layer. SiO₂ is preferably used as the inorganic material to form the undercoat layer as described above. In a wet process, a silica sol or the like may be applied to form a SiO₂ film.

Examples of the organic material include acrylic resins, urethane resins, melamine resins, alkyd resins, siloxane polymers, and organosilane-based condensates. At least one of these organic materials may be used. In particular, a thermosetting resin including a mixture composed of a melamine resin, an alkyd resin and an organosilane condensate is preferably used as the organic material.

When a plurality of undercoat layers 5 are formed, the first undercoat layer from the transparent plastic film substrate 1 is preferably made of an organic material, and the undercoat layer most distant from the transparent plastic film substrate 1 is preferably made of an inorganic material, in view of the processability of the resulting pressure-sensitive adhesive layer-carrying transparent conductive film. When two undercoat layers 5 are formed, therefore, the first undercoat layer from the transparent plastic film substrate 1 is preferably made of an organic material, and the second undercoat layer is preferably made of an inorganic material.

The thickness of the undercoat layer 5 is generally, but not limited to, from about 1 to about 300 nm, preferably from 5 to 300 nm, in view of optical design and the effect of preventing the release of an oligomer from the transparent plastic film substrate 1. When two or more undercoat layers 5 are provided, the thickness of each layer may be from about 5 to about 250 nm, preferably from 10 to 250 nm.

An acrylic pressure-sensitive adhesive is preferably used in the pressure-sensitive adhesive layer 3 of the pressure-sensitive adhesive layer-carrying transparent conductive film of the invention.

The acrylic pressure-sensitive adhesive may include, as a base polymer, an acryl-based polymer including an alkyl(meth)acrylate monomer unit in the main skeleton. The term “(meth)acrylate” means acrylate and/or methacrylate, and “(meth)” is used in the same meaning with respect to the invention. The alkyl group of the alkyl (meth)acrylate as a component of the main skeleton of the acryl-based polymer may have about 1 to about 14 carbon atoms. Specific examples of the alkyl(meth)acrylate include methyl(meth)acrylate, ethyl(meth)acrylate, propyl (meth)acrylate, isopropyl(meth)acrylate, n-butyl (meth)acrylate, isobutyl(meth)acrylate, pentyl (meth)acrylate, hexyl(meth)acrylate, 2-ethylhexyl (meth)acrylate, octyl(meth)acrylate, isooctyl (meth)acrylate, nonyl(meth)acrylate, isononyl (meth)acrylate, decyl(meth)acrylate, dodecyl (meth)acrylate, and stearyl(meth)acrylate. These may be used singly or in any combination. In particular, an alkyl (meth)acrylate having an alkyl group of 1 to 9 carbon atoms is preferred.

In order to improve the tackiness or the heat resistance, one or more of various monomers may be copolymerized into the acryl-based polymer. Specific examples of such a copolymerizable monomer include a carboxyl group-containing monomer, a hydroxyl group-containing monomer, a nitrogen-containing monomer (including a heterocyclic ring-containing monomer), and an aromatic moiety-containing monomer.

Examples of the carboxyl group-containing monomer include acrylic acid, methacrylic acid, carboxyethyl(meth) acrylate, carboxypentyl(meth)acrylate, itaconic acid, maleic acid, fumaric acid, and crotonic acid. In particular, acrylic acid or methacrylic acid is preferred.

Examples of the hydroxyl group-containing monomer include 2-hydroxyethyl(meth)acrylate, 2-hydroxypropyl (meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl (meth)acrylate, and (4-hydroxymethylcyclohexyl)-methyl acrylate.

Examples of the nitrogen-containing monomer for modification include maleimide, N-cyclohexylmaleimide, N-phenylmaleimide; N-acryloylmorpholine; (N-substituted) amide monomers such as (meth)acrylamide, N,N-dimethyl(meth)acrylamide, N,N-diethyl(meth)acrylamide, N-hexyl(meth)acrylamide, N-methyl(meth)acrylamide, N-butyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl(meth)acrylate, aminopropyl(meth)acrylate, N,N-dimethylaminoethyl (meth)acrylate, tert-butylaminoethyl(meth)acrylate, and 3-(3-pyridinyl)propyl(meth)acrylate; alkoxyalkyl (meth)acrylate monomers such as methoxyethyl(meth)acrylate and ethoxyethyl(meth)acrylate; and succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine.

Examples of the aromatic moiety-containing monomer include benzyl(meth)acrylate, phenyl(meth)acrylate, and phenoxyethyl(meth)acrylate.

Examples of monomers other than the above include acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth) acrylamidopropanesulfonic acid, sulfopropyl (meth)acrylate, and (meth)acryloyloxynaphthalenesulfonic acid; and phosphate group-containing monomers such as 2-hydroxyethylacryloyl phosphate.

Examples of additional monomers that may be used include vinyl monomers such as vinyl acetate, vinyl propionate, N-vinylpyrrolidone, methyl vinyl pyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl methacrylate; glycol acrylate monomers such as polyethylene glycol (meth)acrylate, polypropylene glycol (meth)acrylate, methoxyethylene glycol (meth)acrylate, and methoxypolypropylene glycol (meth)acrylate; and acrylic ester monomers such as tetrahydrofurfuryl(meth)acrylate, fluoro(meth)acrylate, silicone (meth)acrylate, and 2-methoxyethyl acrylate.

In particular, hydroxyl group-containing monomers are preferably used, because of their high reactivity with crosslinking agents. In view of tackiness or adhesion durability, carboxyl group-containing monomers such as acrylic acid are preferably used.

The content (in weight ratio) of the copolymerized monomer in the acryl-based polymer may be, but not limited to, 50% by weight or less, preferably from 0.1 to 10% by weight, more preferably from 0.5 to 8% by weight, even more preferably from 1 to 6% by weight.

The weight average molecular weight of the acrylic polymer is preferably, but not limited to, from about 300,000 to about 2,500,000. The acrylic polymer may be produced by a variety of known methods, and, for example, radical polymerization methods such as bulk polymerization, solution polymerization, and suspension polymerization methods may be appropriately selected. In particular, solution polymerization is preferably used. Any of various known radical polymerization initiators such as azo initiators and peroxide initiators may be used. The reaction temperature is generally from about 50 to about 80° C., and the reaction time is generally from 1 to 8 hours. Ethyl acetate, toluene or the like is generally used as a solvent for the acrylic polymer.

The pressure-sensitive adhesive used to form the pressure-sensitive adhesive layer of the invention may include a crosslinking agent in addition to the base polymer. The crosslinking agent can improve the adhesion to the transparent conductive film and the durability and can achieve high temperature reliability or preserve the shape of the pressure-sensitive adhesive itself at high temperature. When the base polymer is an acryl-based polymer, any appropriate crosslinking agent may be used, such as an isocyanate, epoxy, peroxide, metal chelate, or oxazoline crosslinking agent. One or more of these crosslinking agents may be used alone or in any combination.

Isocyanate compounds may be used as isocyanate crosslinking agents. Examples of such isocyanate compounds include isocyanate monomers such as tolylene diisocyanate, chlorophenylene diisocyanate, hexamethylene diisocyanate, tetramethylene diisocyanate, isophorone diisocyanate, xylylene diisocyanate, diphenylmethane diisocyanate, and hydrogenated diphenylmethane diisocyanate, and adduct type isocyanate compounds produced by adding the isocyanate monomer to trimethylolpropane or the like; and urethane prepolymer type isocyanates produced by the addition reaction of isocyanurate compounds, burette type compounds, or known polyether polyols, polyester polyols, acrylic polyols, polybutadiene polyols, polyisoprene polyols, or the like.

Examples of the epoxy crosslinking agent include bisphenol A-epichlorohydrin type epoxy resins. Examples of the epoxy crosslinking agent include ethylene glycol diglycidyl ether, polyethylene glycol diglycidyl ether, glycerol diglycidyl ether, glycerol triglycidyl ether, 1,6-hexanediol diglycidyl ether, trimethylolpropane triglycidyl ether, diglycidylaniline, N,N,N′,N′-tetraglycidyl-m-xylylenediamine, 1,3-bis(N,N-diglycidylaminomethyl)cyclohexane, N,N,N′,N′-tetraglycidylaminophenylmethane, triglycidylisocyanurate, m-N,N-diglycidylaminophenyl glycidyl ether, N,N-diglycidyltoluidine, and N,N-diglycidylaniline.

Various types of peroxides may be used as the peroxide crosslinking agent. Examples of such peroxides include di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutyl peroxyisobutylate, 1,1,3,3-tetramethylbutylperoxy-2-ethyl hexanoate, di(4-methylbenzoyl)peroxide, dibenzoyl peroxide, and tert-butylperoxyisobutylate. Above all, di(4-tert-butylcyclohexyl)peroxydicarbonate, dilauroyl peroxide and dibenzoyl peroxide are preferably used, because their crosslinking reaction efficiency is particularly good.

The crosslinking agent may be used in an amount of 10 parts by weight or less, preferably 0.01 to 5 parts by weight, more preferably 0.02 to 3 parts by weight, based on 100 parts by weight of the acryl-based polymer. Use of more than 10 parts by weight of the crosslinking agent is not preferred, because it may allow crosslinking to proceed excessively so that the tackiness may be reduced.

If necessary, the pressure-sensitive adhesive may conveniently contain various types of additives such as tackifiers, plasticizers, fillers such as glass fibers, glass beads, metal power, or any other inorganic powder, pigments, colorants, antioxidants, ultraviolet absorbers, and silane coupling agents, without departing from the object of the present invention. The pressure-sensitive adhesive layer may also contain fine particles so as to have light diffusion properties.

The pressure-sensitive adhesive layer-carrying transparent conductive film of the invention may be obtained by performing the steps of applying a pressure-sensitive adhesive coating liquid onto a release sheet and forming a pressure-sensitive adhesive layer from the pressure-sensitive adhesive coating liquid.

For the application step, a pressure-sensitive adhesive coating liquid is prepared. The pressure-sensitive adhesive coating liquid may be any of a solution and a dispersion. For the solution, for example, an aromatic solvent such as toluene or an ester solvent such as ethyl acetate is used as a solvent. The concentration of the pressure-sensitive adhesive coating liquid to be used is generally adjusted to about 2 to about 80% by weight, preferably 5 to 60% by weight, more preferably 7 to 50% by weight.

Methods for applying the pressure-sensitive adhesive coating liquid onto the release sheet include, but not limited to, die coating such as closed edge die coating or slot die coating, roll coating such as reverse coating or gravure coating, spin coating, screen coating, fountain coating, dipping, and spraying.

In the step of applying the pressure-sensitive adhesive coating liquid, the dry thickness of the pressure-sensitive adhesive layer to be formed is generally from about 1 to about 40 μm, preferably from 3 to 35 μm, more preferably from 5 to 30 μm, while it may be adjusted as needed.

If the pressure-sensitive adhesive layer is too thin, dents may be more likely to be formed by pen input, and such a pressure-sensitive adhesive layer is not preferred for touch panels. On the other hand, a too thick pressure-sensitive adhesive layer may be reduced in transparency or disadvantageous for the formation of the pressure-sensitive adhesive layer, the workability of bonding to various objects, and cost.

The pressure-sensitive adhesive coating liquid applied onto the release sheet is then dried so that a pressure-sensitive adhesive layer having a surface roughness Ra of 2 to 130 nm is formed. For example, the pressure-sensitive adhesive layer may be formed by a process including performing a first drying process at a temperature of 30 to 80° C. and an air flow rate of 0.5 to 15 m/second and then performing a second drying process at a temperature of 90 to 160° C. and an air flow rate of 0.1 to 25 m/second.

In the first drying process, a pressure-sensitive adhesive layer having a surface with a surface roughness Ra of 2 to 130 nm is formed, while the solvent is evaporated from the pressure-sensitive adhesive coating liquid. In the second drying process, the pressure-sensitive adhesive layer with a surface roughness Ra of 2 to 130 nm is cured (hardened) so that the pressure-sensitive adhesive layer is completed.

The temperature of the first drying process is from 30 to 80° C., preferably from 35 to 70° C., more preferably from 40 to 60° C. If the temperature is less than 30° C., drying may require too long time to remove the solvent, which is not preferred in view of productivity. On the other hand, if the temperature is more than 80° C., drying may proceed excessively so that the surface of the pressure-sensitive adhesive layer cannot be controlled to have the specified surface roughness Ra. The air flow rate is from 0.5 to 15 m/second, preferably from 0.5 to 10 m/second, more preferably from 1 to 5 m/second. If the air flow rate is less than 0.5 m/second, drying may require too long time to remove the solvent, which is not preferred in view of productivity. On the other hand, if the air flow rate is more than 15 m/second, drying may proceed excessively so that the surface of the pressure-sensitive adhesive layer cannot be controlled to have the specified surface roughness Ra. The process time of the first drying process may be from about 10 seconds to about 30 minutes, preferably from 30 seconds to 20 minutes, more preferably from 45 seconds to 10 minutes. Taking into account the relationship between the temperature and the air flow rate, the process time of the first drying process may be so controlled that the surface of the pressure-sensitive adhesive layer can have the specified surface roughness Ra.

The temperature of the second drying process is from 90 to 160° C., preferably from 130 to 160° C., more preferably from 135 to 155° C. If the temperature is less than 90° C., drying may require too long time to remove the solvent, which is not preferred in view of productivity. On the other hand, if the temperature is more than 160° C., the pressure-sensitive adhesive may be undesirably colored. The air flow rate is from 0.1 to 25 m/second, preferably from 1 to 23 m/second, more preferably from 5 to 20 m/second. If the air flow rate is less than 0.1 m/second, drying may require too long time to remove the solvent, which is not preferred in view of productivity. On the other hand, if the air flow rate is more than 25 m/second, there may be an adverse effect on the feeding of the film, which is not preferred. The process time of the second drying process may be from about 10 seconds to about 20 minutes, preferably from 20 seconds to 10 minutes, more preferably from 30 seconds to 3 minutes. Taking into account the relationship between the temperature and the air flow rate, the process time of the second drying process may be so controlled that the pressure-sensitive adhesive layer can be cured (hardened).

In the first or second drying process, for example, an oven, an air heater, a heating roller, a far infrared heater, or the like may be used as a means for controlling the temperature in the specified range. In the first or second drying process, the air flow rate may be controlled in the specified range using a counter flow type air flow means. The distance to the air flow means may be from about 10 to about 100 cm, preferably from 10 to 50 cm. The air flow rate may be measured with a mini-vane digital anemometer. The air flow rate may be measured with an anemometer at a point 3 cm above the pressure-sensitive adhesive coating liquid applied onto the release sheet below the air flow nozzle. The anemometer to be used may be MODEL 1560/SYSTEM 6243 manufactured by KANOMAX JAPAN INC.

The pressure-sensitive adhesive layer 3 formed on one side of the first transparent plastic film substrate 1 preferably has a storage elastic modulus (G′) of 20,000 to 500,000 Pa, more preferably 70,000 to 200,000 Pa at 23° C. If the storage elastic modulus (G′) is less than 20,000 Pa, dents may be more likely to be formed by pen input, which is not preferred when the pressure-sensitive adhesive layer is for use in touch panels. On the other hand, if the storage elastic modulus (G′) is more than 500,000 Pa, the tackiness may be undesirably reduced.

As used herein, the term “storage elastic modulus (G′)” in the invention refers to a dynamic mechanical property, which is described in JIS-K-7244-1 (Plastics, Dynamic Mechanical Property Test Methods, Part 1, General Rules) and the value of which is determined in the torsional deformation mode according to Part 2 of Table 4 in JIS-K-7244-1.

Assuming that stress is the amount of energy per unit volume, when mechanical energy is applied from the outside to a polymer test piece so that a sine motion is imparted to the piece, part of the applied energy is stored in the polymer due to the elasticity, while the remainder is turned into heat and lost by the internal friction. In this process, the temperature may be approximated as constant, because the temperature rise caused by the generation of heat is very small during the test. In this case, the storage elastic modulus G′ corresponds to the stored part, while the loss elastic modulus G″ corresponds to the part lost by the internal friction. Therefore, it is considered that G′ indicates the degree of hardness, while G″ indicates the degree of viscosity.

When a pressure-sensitive adhesive is used, G′ indicates the degree of stress generated by the application of an external force to the pressure-sensitive adhesive layer. Therefore, a larger G′ value means that a higher stress can be generated so that the glass plate can be more strongly warped. On the other hand, if G′ is too small, it may be too soft so that it may have low processability or workability.

The pressure-sensitive adhesive layer preferably has a gel fraction of 70 to 98% by weight, more preferably 85 to 98% by weight, even more preferably 88 to 95% by weight. If the gel fraction is too low, dents may be more likely to be formed by pen input, which is not preferred when the pressure-sensitive adhesive layer is for use in touch panels. On the other hand, if the gel fraction is too high, the tackiness may be undesirably reduced.

Although not shown in FIG. 1 or 2, an oligomer migration-preventing layer is preferably provided between the film substrate 1 and the pressure-sensitive adhesive layer 3. Any appropriate material capable of forming a transparent film may be used to form the migration-preventing layer. Such a material may be an inorganic material, an organic material or a composite thereof. The migration-preventing layer preferably has a thickness of 0.01 to 20 μm. The migration-preventing layer is often formed using a coating method with a coater, a spraying method, a spin coating method, an in-line coating method, or the like, while it may be formed using vacuum deposition, sputtering, ion plating, spray thermal decomposition, chemical plating, electroplating, or the like. The coating method may be performed using a resin component such as an acrylic resin, a urethane resin, a melamine resin, a UV-curable resin, or an epoxy resin, or a mixture of any of the above resins and inorganic particles of alumina, silica, mica, or the like. Alternatively, a substrate containing a component capable of functioning as the migration-preventing layer may be formed by coextrusion of two or more layers. Such a method as vacuum deposition, sputtering, ion plating, spray thermal decomposition, chemical plating, or electroplating may be performed using a metal such as gold, silver, platinum, palladium, copper, aluminum, nickel, chromium, titanium, iron, cobalt, tin, or an alloy thereof, a metal oxide such as indium oxide, tin oxide, titanium oxide, cadmium oxide, or a mixture thereof, or any other metal compound such as a metal iodide.

The anchoring force of the pressure-sensitive adhesive layer 3 may be improved using an anchor layer. The anchor layer is generally provided on the film substrate 1 side.

The material capable of forming the anchor layer may be of any type as long as it can be a layer improving the anchoring force of the pressure-sensitive adhesive. Specific examples of the material that may be used include so-called coupling agents such as a silane-based coupling agent having a reactive functional group such as an amino group, a vinyl group, an epoxy group, a mercapto group, or a chloro group and a hydrolyzable alkoxysilyl group in the same molecule, a titanate-based coupling agent having a titanium-containing hydrolyzable hydrophilic group and an organic functional group in the same molecule, and an aluminate-based coupling agent having an aluminum-containing hydrolyzable hydrophilic group and an organic functional group in the same molecule; and a resin having an organic reactive group, such as an epoxy-based resin, an isocyanate-based resin, a urethane-based resin, or an ester urethane-based resin. In particular, a silane coupling agent-containing layer is preferred, because it is easy to handle industrially.

The pressure-sensitive adhesive layer-carrying transparent conductive film of the invention may be produced by any method capable of forming the structure described above. A general production method may include forming the transparent conductive thin film 2 (and the undercoat layer 5 in some cases) on one side of the transparent plastic film substrate 1 to form the transparent conductive film and then forming the pressure-sensitive adhesive layer 3 on the other side of the transparent plastic film substrate 1. The pressure-sensitive adhesive layer 3 may be formed directly on the transparent plastic film substrate 1. Alternatively, the pressure-sensitive adhesive layer 3 may be formed on the release film 4 and then attached to the transparent plastic film substrate 1. The latter process is more advantageous in terms of productivity, because it allows continuous formation of the transparent pressure-sensitive adhesive layer 3 on the film substrate 1 used in the form of a roll.

A second transparent plastic film substrate 1′ as shown in FIG. 3 may be bonded by a process including forming the pressure-sensitive adhesive layer 3 on the second transparent plastic film substrate 1′ and then attaching the film substrate 1 thereto or a process including forming the transparent pressure-sensitive adhesive layer 3 contrarily on the film substrate 1 and then attaching the second transparent plastic film substrate 1′ thereto. The latter process is more advantageous in terms of productivity, because it allows continuous formation of the transparent pressure-sensitive adhesive layer 3 on the film substrate 1 used in the form of a roll.

The second transparent plastic film substrate 1′ may be a single-layer structure as shown in FIG. 3. Alternatively, two or more second transparent plastic film substrates 1′ may be laminated together with a transparent pressure-sensitive adhesive layer(s) to form a composite structure, which can increase the mechanical strength and other properties of the entire laminate. While FIG. 3 shows a case where the second transparent plastic film substrate 1′ is bonded in place of the release sheet 4 of the pressure-sensitive adhesive layer-carrying transparent conductive film shown in FIG. 1, a transparent conductive laminate may be similarly formed by bonding the second transparent plastic film substrate 1′ in place of the release sheet 4 of the pressure-sensitive adhesive layer-carrying transparent conductive film shown in FIG. 2.

A description will be given of a case where a single-layer structure is used as the second transparent plastic film substrate 1′. When the transparent conductive laminate is required to be flexible even after the single-layered second transparent plastic film substrate 1′ is bonded, a plastic film with a thickness of about 6 to about 300 μm is generally used as the second transparent plastic film substrate 1′. When such flexibility is not particularly required, a glass plate or plastic film or plate with a thickness of about 0.05 to about 10 mm is generally used as the second transparent substrate 1′. The plastic material may be the same as that of the film substrate 1. When a multi-layer structure is used as the second transparent plastic film substrate 1′, the same thickness as described above is preferably used.

In the transparent conductive laminate, a hard coat layer may be provided on one or both sides of the second transparent plastic film substrate 1′. In FIG. 4, a hard coat layer 6 is provided on one side (which is not bonded to the pressure-sensitive adhesive layer 3) of the second transparent plastic film substrate 1′. The hard coat layer 6 may be formed by subjecting the second transparent plastic film substrate 1′ to a hard coating process. For example, the hard coating process may be performed by a method including applying a hard resin such as an acrylic-urethane resin or a siloxane resin and curing the hard resin. The hard coating process may include adding a silicone resin or the like to the hard resin such as the acrylic-urethane resin or the siloxane resin to form a roughened surface, so that a non-glare surface capable of preventing reflections by a mirror effect in practical applications such as touch panels can be formed at the same time.

A too thin hard coat layer may have insufficient hardness, while a too thick hard coat layer may be cracked. Also in view of the property of preventing curling and the like, the thickness of the hard coat layer is preferably from about 0.1 to about 30 μm.

In addition to the hard coat layer 6, if necessary, an anti-glare or anti-reflection layer for improving the visibility may also be formed on the outer surface (which is not bonded to the pressure-sensitive adhesive layer 3) of the second transparent plastic film substrate 1′.

The pressure-sensitive adhesive layer-carrying transparent conductive film or transparent conductive laminate of the invention may be used to form various devices such as touch panels and liquid crystal displays. In particular, the pressure-sensitive adhesive layer-carrying transparent conductive film or transparent conductive laminate of the invention is preferably used as a touch panel electrode plate.

A touch panel includes: a touch-side electrode plate having a transparent conductive thin film; a display-side electrode plate having a transparent conductive thin film; and spacers, wherein the transparent conductive thin films are opposed to each other with the spacers interposed therebetween. The touch panel electrode plate including the transparent conductive film of the invention may be used as any of the touch-side electrode plate and the display-side electrode plate. In particular, unevenness caused by the pressure-sensitive adhesive is significantly reduced in the touch panel electrode plate produced with the pressure-sensitive adhesive layer-carrying transparent conductive film or transparent conductive laminate of the invention, so that the touch panel electrode plate can preferably satisfy display characteristics.

### EXAMPLES

The invention is more specifically described with reference to examples below, however, the invention is not limited to the examples below as long as it is not departing from the gist thereof. In each example, “parts” and “%” are all by weight.

### Production Example 1

### Preparation of Acrylic Pressure-Sensitive Adhesive

To a four-neck flask equipped with a nitrogen introducing tube and a condenser tube were added 96.5 parts of butyl acrylate, 3 parts of acrylic acid, 0.5 parts of 2-hydroxyethyl acrylate, 0.15 parts of 2,2′-azobisisobutyronitrile, and 100 parts of ethyl acetate. After the air was sufficiently replaced by nitrogen, the mixture was allowed to react at 60° C. for 8 hours with stirring under a nitrogen stream, so that a solution of an acryl-based polymer with a weight average molecular weight of 1,650,000 was obtained. Based on 100 parts of the solids of the acryl-based polymer solution, 0.5 parts of an isocyanate crosslinking agent (CORONATE L, manufactured by NIPPON POLYURETHANE INDUSTRY CO., LTD.) was added to the acryl-based polymer solution, so that a pressure-sensitive adhesive coating liquid (12% in solids content) was prepared.

### Production Example 2

### Preparation of Acrylic Pressure-Sensitive Adhesive

To a four-neck flask equipped with a nitrogen introducing tube and a condenser tube were added 99.5 parts of butyl acrylate, 0.5 parts of 4-hydroxybutyl acrylate, 0.15 parts of 2,2′-azobisisobutyronitrile, and 100 parts of ethyl acetate. After the air was sufficiently replaced by nitrogen, the mixture was allowed to react at 60° C. for 8 hours with stirring under a nitrogen stream, so that a solution of an acryl-based polymer with a weight average molecular weight of 1,650,000 was obtained. Based on 100 parts of the solids of the acryl-based polymer solution, 0.1 parts of an isocyanate crosslinking agent (CORONATE L, manufactured by NIPPON POLYURETHANE INDUSTRY CO., LTD.) and 0.05 parts of an epoxy crosslinking agent (TETRAD-C, manufactured by MITSUBISHI GAS CHEMICAL COMPANY, INC.) were added to the acryl-based polymer solution, so that a pressure-sensitive adhesive coating liquid (11.5% in solids content) was prepared.

### Production Example 3

### Preparation of Acrylic Pressure-Sensitive Adhesive

To a four-neck flask equipped with a nitrogen introducing tube and a condenser tube were added 90 parts of butyl acrylate, 4 parts of acrylic acid, 5 parts of acryloylmorpholine, 1 part of 4-hydroxyethyl acrylate, 0.15 parts of 2,2′-azobisisobutyronitrile, and 100 parts of ethyl acetate. After the air was sufficiently replaced by nitrogen, the mixture was allowed to react at 60° C. for 8 hours with stirring under a nitrogen stream, so that a solution of an acryl-based polymer with a weight average molecular weight of 1,650,000 was obtained. Based on 100 parts of the solids of the acryl-based polymer solution, 0.3 parts of an isocyanate crosslinking agent (CORONATE L, manufactured by NIPPON POLYURETHANE INDUSTRY CO., LTD.) was added to the acryl-based polymer solution, so that a pressure-sensitive adhesive coating liquid (11.5% in solids content) was prepared.

### Example 1

The pressure-sensitive adhesive coating liquid obtained in Production Example 1 was applied with a die coater to the release-treated surface (21 nm in surface roughness) of a release-treated polyester film (release sheet A, Diafoil MRF#38 (trade name) manufactured by Mitsubishi Chemical Polyester Co., Ltd., 38 μm in thickness) so that the coating would have a dry thickness of 22 μm. The coating was then subjected to a first drying process in which air was blown at a flow rate of 15 m/second in an oven at 80° C. for 1 minute. The coating was then subjected to a second drying process in which air was blown at a flow rate of 15 m/second and a temperature of 150° C. for 2 minutes, so that a pressure-sensitive adhesive layer was formed on the release sheet A.

The surface roughness Ra of the resulting pressure-sensitive adhesive layer was evaluated as described below. The result is shown in Table 1-2.

Surface Roughness (Ra)

Another release sheet B (release-treated polyester film, Diafoil MRF#38 (trade name) manufactured by Mitsubishi Chemical Polyester Co., Ltd., 38 μm in thickness) was bonded to the resulting pressure-sensitive adhesive layer on the release sheet A. Thereafter, the originally attached release sheet A was peeled off, and the pressure-sensitive adhesive layer was bonded to a glass plate (MICRO SLIDE GLASS, manufactured by Matsunami Glass Ind., Ltd.) to form a sample. The sample was so placed that the release sheet B attached later was placed to face upward. The release sheet B was then peeled off from the pressure-sensitive adhesive layer, and the surface roughness Ra of the pressure-sensitive adhesive layer was measured. In the measurement, WYKO NT3300 (a non-contact three-dimensional roughness tester, manufactured by Veeco Instruments.) was used to observe an area of 20 mm×20 mm, and the surface roughness Ra was measured at three points at intervals of 5 mm in a direction perpendicular to the coating direction of the pressure-sensitive adhesive layer. Table 1-2 shows the average of the surface roughness Ra measurements. The surface roughness Ra was measured according to JIS B 0601.

Formation of Undercoat Layer

A 25 μm-thick polyethylene terephthalate film (hereinafter referred to as “PET film”), on one side of which a migration preventing layer (1 μm thick, made from a urethane acrylic-based ultraviolet-curable resin) was provided, was used as a transparent plastic film substrate. A 180 nm-thick first undercoat layer was formed on the other side of the film substrate using a thermosetting resin composed of a melamine resin, an alkyd resin and an organosilane condensate (2:2:1 in weight ratio). SiO₂ was then vacuum-deposited on the first undercoat layer by electron-beam heating at a degree of vacuum of 1.33×10⁻² to 2.67×10⁻² Pa to form a 40 nm-thick second undercoat layer (SiO₂ film).

Formation of Transparent Conductive Thin Film

A 20 nm-thick ITO film was then formed on the second undercoat layer by a reactive sputtering method in a 5.33×10⁻² Pa atmosphere of 80% argon gas and 20% oxygen gas using a material of 95% by weight of indium oxide and 5% by weight of tin oxide, so that a transparent conductive film was obtained. The ITO film was amorphous.

Preparation of Pressure-Sensitive Adhesive Layer-Carrying Transparent Conductive Film

The transparent conductive film (the surface on which no ITO film was formed) was bonded to the pressure-sensitive adhesive layer provided on the release sheet A, so that a pressure-sensitive adhesive layer-carrying transparent conductive film was obtained. The surface resistance of the ITO film was 300 Ω/square. The surface resistance (Ω/square) of the ITO film was measured using Lowrester Resistance Meter manufactured by Mitsubishi Chemical Co., Ltd.

### Examples 2 to 7 and Comparative Examples 1 to 3

Pressure-sensitive adhesive layer-carrying transparent conductive films were obtained using the process of Example 1, except that the type of the pressure-sensitive adhesive coating liquid and the conditions of the first and second drying processes were changed as shown in Table 1-1.

The visibility was evaluated as described below with respect to the pressure-sensitive adhesive layer-carrying transparent conductive films. The results are shown in Table 1-2.

Visibility

The release sheet was peeled off from the resulting pressure-sensitive adhesive layer-carrying transparent conductive film. The pressure-sensitive adhesive layer was then bonded to a glass substrate, and the resulting laminate was visually observed for visibility in two directions (the normal direction and a 45° oblique direction) according to the following criteria.

⊚: There was no problem with the visibility.
◯: A certain acceptable level of unevenness was observed.
x: There was a problem with the visibility.

TABLE 1-1

| | Type of | First drying process | | Second drying process | |
|---|---|---|---|---|---|
| | pressure- | Tem- | Air flow | Tem- | Air flow |
| | sensitive | perature | rate | perature | rate |
| | adhesive | (° C.) | (m/second) | (° C.) | (m/second) |
| Examples 1 | Production | 80 | 15 | 150 | 15 |
| | Example 1 | | | | |
| Examples 2 | Production | 60 | 10 | 130 | 10 |
| | Example 1 | | | | |
| Examples 3 | Production | 50 | 10 | 50 | 10 |
| | Example 1 | | | | |
| Examples 4 | Production | 60 | 7 | 130 | 5 |
| | Example 2 | | | | |
| Examples 5 | Production | 30 | 3 | 130 | 5 |
| | Example 2 | | | | |
| Examples 6 | Production | 30 | 0.5 | 130 | 0.1 |
| | Example 2 | | | | |
| Examples 7 | Production | 50 | 0.5 | 155 | 0.1 |
| | Example 3 | | | | |
| Comparative | Production | 90 | 20 | 155 | 20 |
| Examples 1 | Example 1 | | | | |
| Comparative | Production | 90 | 20 | 150 | 10 |
| Examples 2 | Example 2 | | | | |
| Comparative | Production | 90 | 20 | 155 | 20 |
| Examples 3 | Example 3 | | | | |

TABLE 1-2

| | |
|---|---|
| Surface | |
| roughness | |
| Ra of | |
| pressure- | |
| sensitive | Visibility |

| | adhesive | | 45° |
|---|---|---|---|
| | layer | Normal | oblique |
| | (nm) | direction | direction |
| Examples 1 | 128 | ◯ | ◯ |
| Examples 2 | 116 | ⊚ | ◯ |
| Examples 3 | 83 | ⊚ | ⊚ |
| Examples 4 | 64 | ⊚ | ⊚ |
| Examples 5 | 50 | ⊚ | ⊚ |
| Examples 6 | 43 | ⊚ | ⊚ |
| Examples 7 | 44 | ⊚ | ⊚ |
| Comparative | 190 | X | X |
| Examples 1 | | | |
| Comparative | 183 | X | X |
| Examples 2 | | | |
| Comparative | 171 | X | X |
| Examples 3 | | | |

What is claimed is:

1. A pressure-sensitive adhesive layer-carrying transparent conductive film, comprising:
a first transparent plastic film substrate;
a transparent conductive thin film provided on one side of the first transparent plastic film substrate; and
a pressure-sensitive adhesive layer provided on another side of the first transparent plastic film substrate, wherein
the pressure-sensitive adhesive layer used in the pressure-sensitive adhesive layer-carrying transparent conductive film has a surface with a surface roughness Ra of 2 to 130 nm on the side to which the first transparent plastic film substrate is bonded.

2. The pressure-sensitive adhesive layer-carrying transparent conductive film according to claim 1, wherein an acrylic pressure-sensitive adhesive is used in the pressure-sensitive adhesive layer.

3. The pressure-sensitive adhesive layer-carrying transparent conductive film according to claim 1, further comprising at least one undercoat layer interposed between the transparent conductive thin film and the first transparent plastic film substrate.

4. The pressure-sensitive adhesive layer-carrying transparent conductive film according to claim 1, further comprising a release sheet bonded to a surface of the pressure-sensitive adhesive layer opposite to the first transparent plastic film substrate.

5. A transparent conductive laminate, comprising: the pressure-sensitive adhesive layer-carrying transparent conductive film according to claim 1; and a second transparent plastic film substrate bonded to the pressure-sensitive adhesive layer of the pressure-sensitive adhesive layer-carrying transparent conductive film.

6. The transparent conductive laminate according to claim 5, further comprising a hard coat layer provided on one or both sides of the second transparent plastic film substrate.

7. A touch panel, comprising at least one piece of the pressure-sensitive adhesive layer-carrying transparent conductive film according to claim 1.

8. A touch panel, comprising at least one piece of the transparent conductive laminate according to claim 5.

9. A method for producing the pressure-sensitive adhesive layer-carrying transparent conductive film according to claim 4, comprising the steps of:
applying a pressure-sensitive adhesive coating liquid onto a release sheet; and
subjecting the pressure-sensitive adhesive coating liquid to a first drying process at a temperature of 30 to 80° C. and an air flow rate of 0.5 to 15 m/second and a second drying process at a temperature of 90 to 160° C. and an air flow rate of 0.1 to 25 m/second to form a pressure-sensitive adhesive layer.
